(19) United States
(12) Patent Application Publication
(10) Pub. No.: US 2020/0234120 A1
(43) Pub. Date: Jul. 23, 2020

(54) GENERATION OF TENSOR DATA FOR LEARNING BASED ON A RANKING RELATIONSHIP OF LABELS

(71) Applicant: FUJITSU LIMITED, Kawasaki-shi (JP)

(72) Inventor: TATSURU MATSUO, Kawasaki (JP)

(73) Assignee: FUJITSU LIMITED, Kawasaki-shi (JP)

(21) Appl. No.: 16/734,615

(22) Filed: Jan. 6, 2020

(30) Foreign Application Priority Data
Jan. 21, 2019 (JP) 2019-008004

(51) Int. Cl. G06N 3/08; G06N 3/04

(52) U.S. Cl. CPC G06N 3/08; G06N 3/04

(57) ABSTRACT

An apparatus accepts graph data having a graph structure that includes a plurality of nodes and attributes respectively set to the plurality of nodes, and generates tensor data which has a dimension corresponding to each of the plurality of nodes and each of the attributes, and in which a relationship value indicating existence of a corresponding relationship is set for first relationships between the plurality of nodes and the attributes and second relation ships between the plurality of nodes. Upon learning ranking relationships between the attributes by using each of the attributes as a label, the apparatus sets the relationship value to an attribute value range of each of the attributes in the tensor data, where the attribute value range corresponds to the ranking relationships.

### CROSS-REFERENCE TO RELATED APPLICATION

This application is based upon and claims the benefit of priority of the prior Japanese Patent Application No. 2019-8004, filed on Jan. 21, 2019, the entire contents of which are incorporated herein by reference.

### FIELD

The embodiments described herein are related to generation of tensor data for learning based on a ranking relationship of labels.

### BACKGROUND

Data relating to link of people or things (hereinafter sometimes referred to as relationship data) is learned or predicted, such as soundness of an organization that is a link between a person and a person, and activity of a compound that is a link between an atom and an atom. In such learning, a technique is used to represent relationship data as a graph, and to learn the relationship data by a technique capable of learning the graph. When the relationship data is represented by the graph, learning for determining same or different labels is performed for labels attached to nodes. For example, when a label “20s” is attached to a node of a person A, learning is executed as a positive example, and when the label “20s” is not attached, the learning is executed as a negative example.

International Publication Pamphlet No. WO 2010/134319 and Japanese Laid-Open Patent Publication No. 2018-055580 are examples of related art.

### SUMMARY

According to an aspect of the embodiments, an apparatus accepts graph data having a graph structure that includes a plurality of nodes and attributes respectively set to the plurality of nodes, and generates tensor data which has a dimension corresponding to each of the plurality of nodes and each of the attributes, and in which a relationship value indicating existence of a corresponding relationship is set for first relationships between the plurality of nodes and the attributes and second relation ships between the plurality of nodes. Upon learning ranking relationships between the attributes by using each of the attributes as a label, the apparatus sets the relationship value to an attribute value range of each of the attributes in the tensor data, where the attribute value range corresponds to the ranking relationships.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining a learning apparatus according to a first embodiment;

FIG. 2 is a diagram for explaining a learning example of a deep tensor;

FIG. 3 is a diagram for explaining graph representation and tensor representation;

FIG. 4 is a diagram for explaining graph representation and tensor representation to which labels are applied;

FIG. 5 is a diagram for explaining each representation focused on people and age groups;

FIG. 6 is a diagram for explaining a problem of a common technique;

FIG. 7 is a functional block diagram illustrating a functional configuration of the learning apparatus according to the first embodiment;

FIG. 8 is a diagram illustrating an example of information stored in an input data database (DB);

FIG. 9 is a diagram for explaining conversion from input data to learning data;

FIG. 10 is a diagram for explaining a generation example of learning data;

FIG. 11 is a diagram for explaining learning processing and prediction processing;

FIG. 12 is a flowchart illustrating a processing procedure according to the first embodiment;

FIG. 13 is a diagram for explaining conversion from input data to learning data according to a second embodiment;

FIG. 14 is a diagram for explaining learning processing and prediction processing according to the second embodiment;

FIG. 15 is a diagram for explaining tensor representation of learning data according to a third embodiment; and

FIG. 16 is a diagram for explaining an example of a hardware configuration.

### DESCRIPTION OF EMBODIMENTS

When the relationship data is represented by the graph, there may exist a rule based on a ranking relationship for the labels, such as a rule in which “it is a positive example when there is a link between people in their 30s or older”. However, in the above technique, since the labels are only determined whether the labels are same or different, it is not possible to perform learning in which the rule based on the ranking relationship is determined.

In one aspect, it is desirable to perform learning based on a ranking relationship of labels.

Hereinafter, embodiments of a tensor generation program, a tensor generation method, and a tensor generation apparatus disclosed in the present application will be described in detail with reference to the accompanying drawings. This disclosure is not limited by the embodiments. The embodiments may be appropriately combined as long as there is no contradiction.

### First Embodiment

[Explanation of Learning Apparatus]

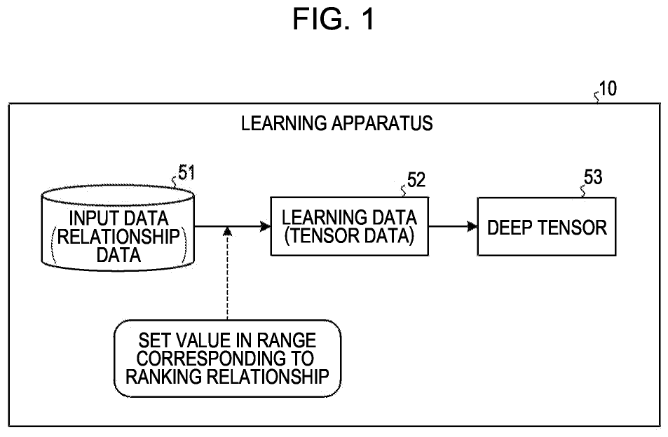

FIG. 1 is a diagram for explaining a learning apparatus 10 according to the first embodiment. The learning apparatus 10 illustrated in FIG. 1 is an example of a tensor generating apparatus, and constructs a learning model by using a machine learning technique such as a deep tensor (reference: Japanese Laid-Open Patent Publication No. 2018-055580) in which input data that is a learning target is represented by a graph and the graph may be learned. For example, the learning apparatus 10 converts the input data 51 represented by the graph into tensor data 52 in a tensor format. The learning apparatus 10 inputs the tensor data 52 to a deep tensor 53 using a neural network, performs learning by using the deep tensor 53, and constructs a learning model.

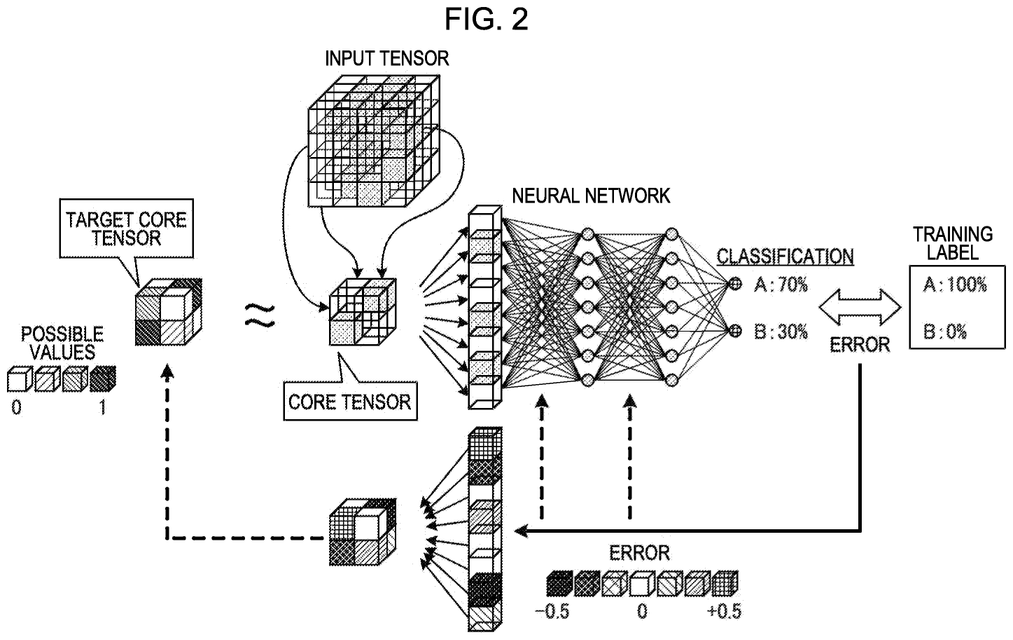

The learning by using the deep tensor will be described. FIG. 2 is a diagram for explaining a learning example of a deep tensor. As illustrated in FIG. 2, the learning apparatus 10 generates tensor data in which a graph structure of input data to which a label is applied is represented by tensor representation. The learning apparatus 10 performs tensor decomposition on the generated tensor data as an input tensor, and generates a core tensor so as to be similar to a target core tensor generated at random at the first time. The learning apparatus 10 inputs the core tensor to the neural network to acquire a classification result (label A: 70%, label B: 30%). Thereafter, the learning apparatus 10 calculates a classification error between the classification result (label A: 70%, label B: 30%) and a training label (label A: 100%, label B: 0%).

The learning apparatus 10 performs learning of a prediction model by using an expanded error propagation method in which an error reverse propagation method is expanded. That is, the learning apparatus 10 corrects various parameters of the neural network so as to reduce a classification error in such a manner that the classification error is propagated to a lower layer with respect to an input layer, an intermediate layer, and an output layer which are included in the neural network. The learning apparatus 10 propagates the classification error to the target core tensor, and modifies the target core tensor so as to approach a partial structure of the graph contributing to prediction, that is, a characteristic pattern indicating characteristics of each label. In this way, a partial pattern contributing to the prediction is extracted to the optimized target core tensor.

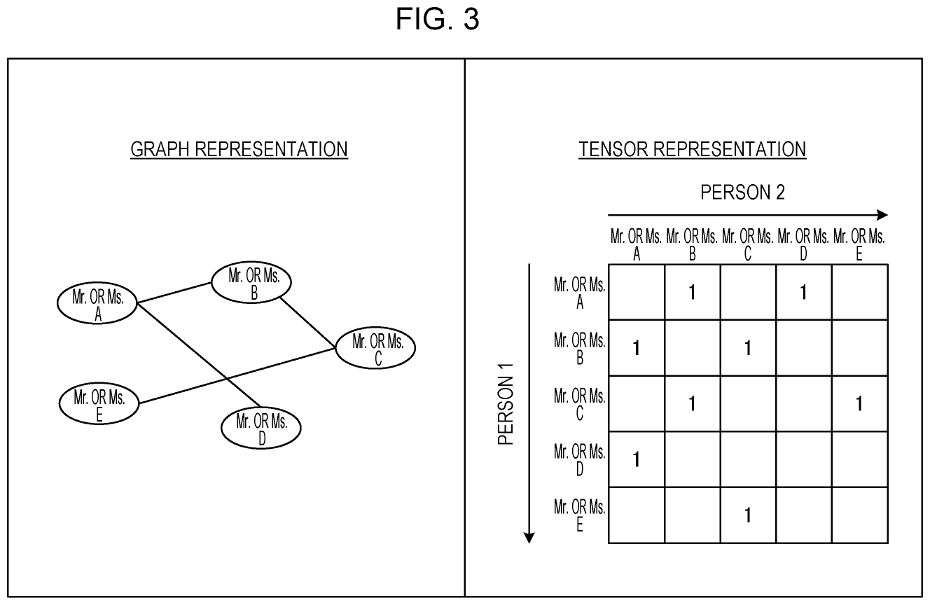

In many cases, in the learning by the deep tensor described above, the graph is expressed by the tensor, and the tensor data is learned. FIG. 3 is a diagram for explaining graph representation and tensor representation. As illustrated in FIG. 3, input data is relationship data having a graph structure indicating a link (relationship) between a person and a person, with person information indicating each person such as Mr. or Ms. A, or Mr. or Ms. B being used as a node. When the graph representation of the input data is represented by the tensor representation, the tensor representation may be represented by an adjacency matrix configured with a person 1 and a person 2, as an example.

In this adjacency representation, 1 is set as an attribute value in an element with a link, and 0 is set as an attribute value in an element in which there is no link. For example, since there is a link (relationship) between the person 1 (Mr. or Ms. A) and the person 2 (Mr. or Ms. B), 1 is set, and since there is no link between the person 1 (Mr. or Ms. A) and the person 2 (Mr. or Ms. E), 0 is set. In FIG. 3, 0 is omitted, and 0 is omitted in the drawings of the embodiment.

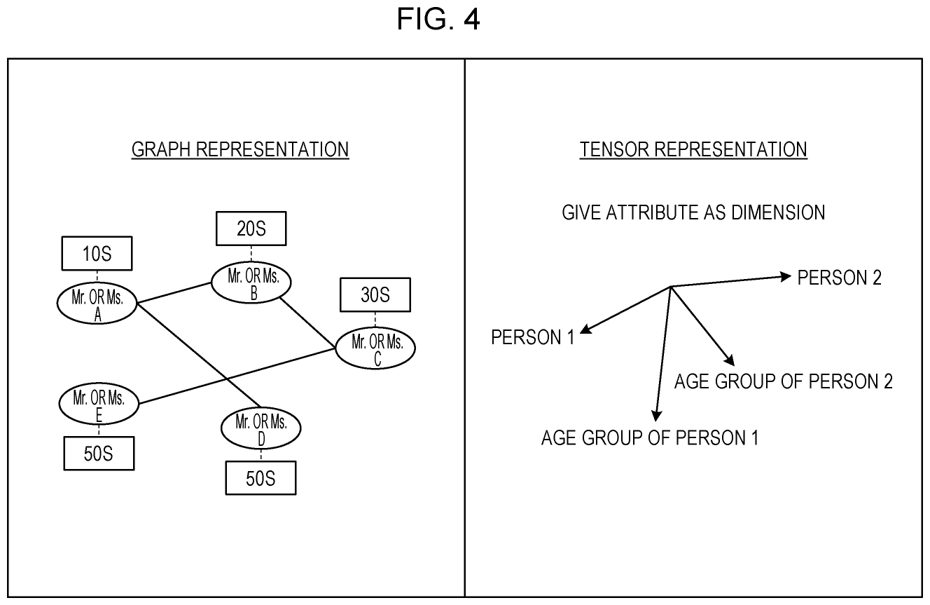

FIG. 4 is a diagram in which a label is set as an attribute for each person. FIG. 4 is a diagram for explaining graph representation and tensor representation to which labels are applied. As illustrated in FIG. 4, in the graph representation, an age group such as 10s is applied to each person such as Mr. or Ms. A as a label. When this state is represented by the tensor representation, each attribute is applied as a dimension, so that 1 is set in a four-dimensional space represented by respective axes of the person 1, an age group (label) of the person 1, the person 2, and an age group (label) of the person 2.

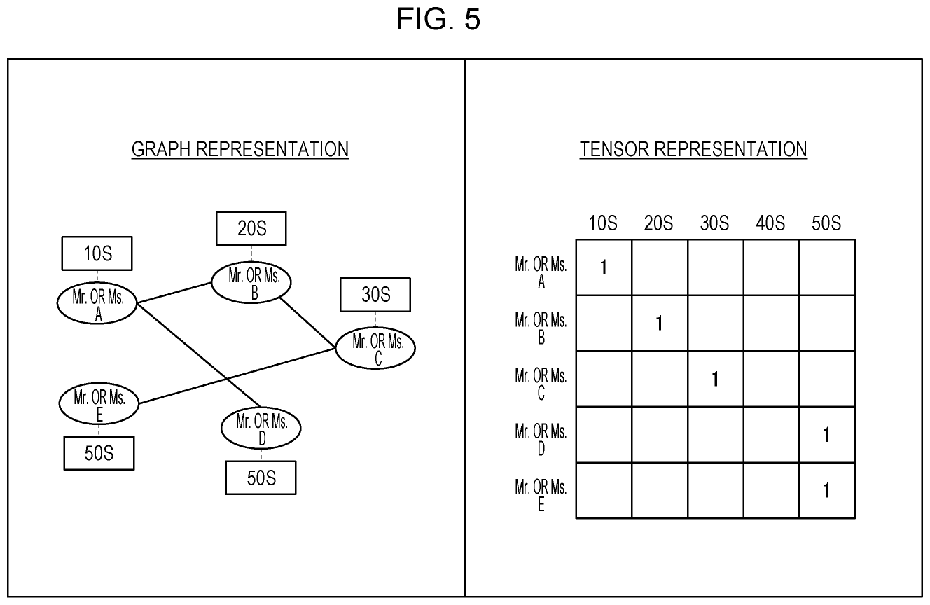

FIG. 5 is a diagram in which the four-dimensional space is simplified. FIG. 5 is a diagram for explaining each representation focused on people and age groups. As illustrated in FIG. 5, when graph representation to which labels are applied is represented by tensor representation focused on a relationship between a person and an age group, the tensor representation may be represented by adjacency representation configured with the person 1 and an age group (label) set to the person 1. For example, 1 is set to an element corresponding to Mr. or Ms. A and 10s, and 0 is set to each of elements corresponding to Mr. or Ms. A and the other age groups.

When data to which the label such as the age group is applied is used as learning data, it is also conceivable to learn a rule based on a ranking relationship for the labels, such as a rule in which “it is a positive example when there is a link between people in their 30s or older”. At this time, even in a case of machine learning such as a deep tensor commonly used, when pieces of data having attributes (labels) of 30s and 50s are sufficiently present, it is possible to learn rules for these age groups. However, when the number of pieces of data of 40s is small, it is not possible to learn whether or not the rule is true continuously from 30s to 50s.

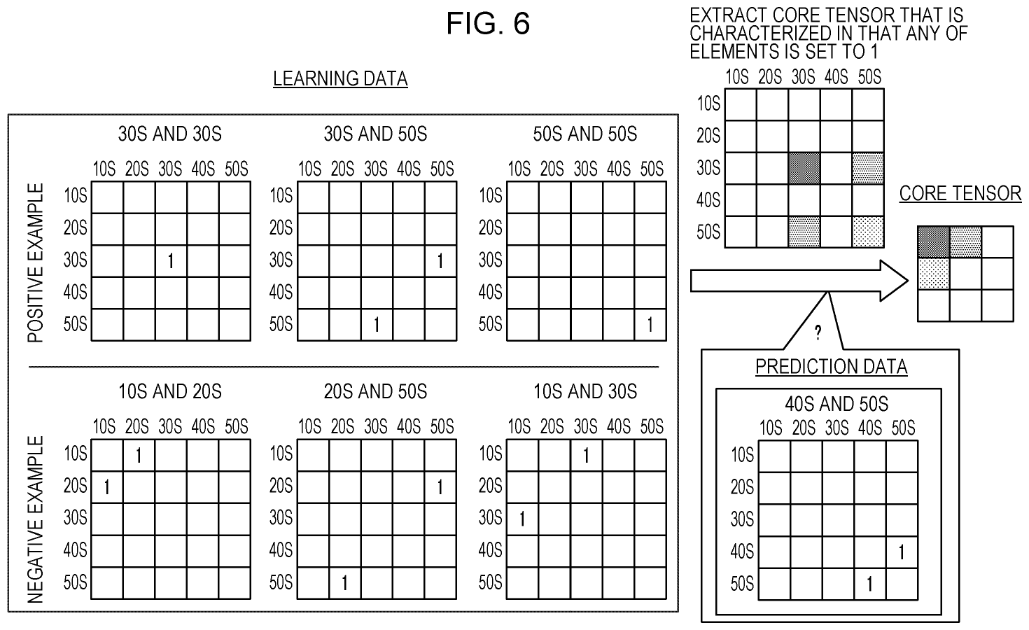

FIG. 6 is a diagram for explaining a problem of a common technique. In FIG. 6, representation is used in which attention is paid only to the age groups of people having a link as tensor representation. For example, in an adjacency matrix having the respective age groups as a vertical axis and a horizontal axis, when the person 1 in his or her 30s and the person 2 in his or her 50s have a link, 1 is set to an element indicating the vertical axis (30s) and the horizontal axis (50s), and 1 is set to an element indicating the vertical axis (50s) and the horizontal axis (30s). In the following description, the vertical axis and the horizontal axis are omitted, and the element is simply denoted as an element of 30s and 50s, or the like.

In an example illustrated in FIG. 6, as learning data of a positive example, data in which 30s and 30s have a link, data in which 30s and 50s have a link, and data in which 50s and 50s have a link are prepared. As learning data of a negative example, data in which 10s and 20s have a link, data in which 20s and 50s have a link, and data in which 10s and 30s have a link are prepared.

An example is considered in which a rule in which “it is a positive example when there is a link between people in their 30s or older” is learned by a deep tensor by using such learning data. In this case, since the deep tensor extracts and learns characteristics of the learning data of the positive example as a core tensor, it extracts the core tensor which is characterized in that any one of elements (1) 30s and 30s, (2) 30s and 50s, (3) 50s and 30s, and (4) 50s and 50s is 1, and learns a learning model.

After completion of learning, a case is considered where prediction data in which 40s and 50s have a link is input to a learned learning model to be predicted. Since this prediction data corresponds to a case where “there is a link between people in their 30s or older”, it is supposed to be predicted as a positive example, but the element to which “1” is set does not correspond to any of the above elements (1) to (4). Therefore, in the common technique, since the predicted data does not match the learned characteristics, it is not possible to predict as a positive example. In this way, in the common technique, since the labels are only determined whether the labels are same or different, it is not possible to perform learning in which the rule based on the ranking relationship is determined.

Therefore, in the first embodiment, the rule, based on the ranking relationship, that may not be represented as a label of a node to be represented as a graph is made to correspond to the tensor representation, thereby enabling learning including the ranking relationship. For example, the learning apparatus 10 according to the first embodiment generates tensor data having a dimension corresponding to a plurality of nodes and an attribute that is a source of a label applied to each of the plurality of nodes, based on a graph structure of input data. At this time, the learning apparatus 10 generates tensor data that have values corresponding to relationships between the plurality of nodes and attributes that are the sources of the labels applied to the plurality of nodes, and values corresponding to relationships among the plurality of nodes. With respect to attributes having the ranking relationship among attributes that are the sources of the respective labels applied to the plurality of nodes, the learning apparatus 10 generates tensor data that have values of the attributes and values in a range corresponding to the ranking relationship of the attributes.

As described above, the learning apparatus 10 uses, as learning data, new tensor data in which a value (for example, 1) is set for the element corresponding to the range of the ranking relationship with respect to tensor data obtained by generating a tensor from the graph structure as it is. As a result, by associating even items that are difficult to represent as labels of nodes when the items are represented as a graph, such as the rule based on the ranking relationship, with representation of a tensor, the learning apparatus 10 may perform learning including these items.

[Functional Configuration]

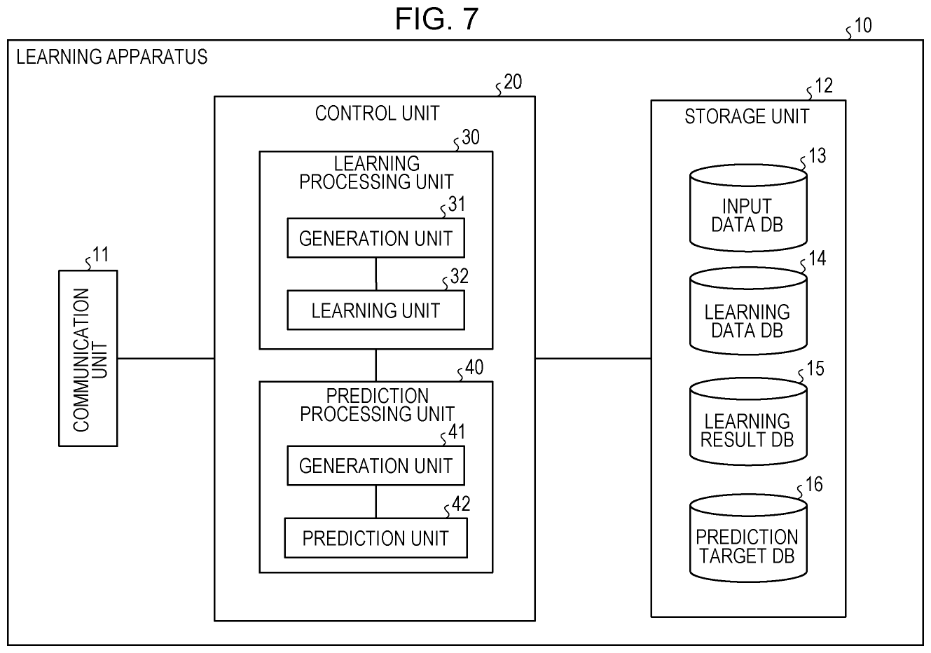

FIG. 7 is a functional block diagram illustrating a functional configuration of the learning apparatus 10 according to the first embodiment. As illustrated in FIG. 7, the learning apparatus 10 includes a communication unit 11, a storage unit 12, and a control unit 20.

The communication unit 11 is a processing unit that controls communication with another device and is, for example, a communication interface or the like. For example, the communication unit 11 receives a learning start instruction and various data from an administrator terminal used by an administrator, and transmits a learning result, a prediction result, and the like to the administrator terminal.

The storage unit 12 is an example of a storage device storing data and various programs that are executed by the control unit 20, and is, for example, a memory, a hard disk, or the like. The storage unit 12 stores an input data DB 13, a learning data DB 14, a learning result DB 15, and a prediction target DB 16.

The input data DB 13 is a database for storing input data that is a generation source of learning data. For example, the input data DB 13 stores tensor data generated from input data having a graph structure.

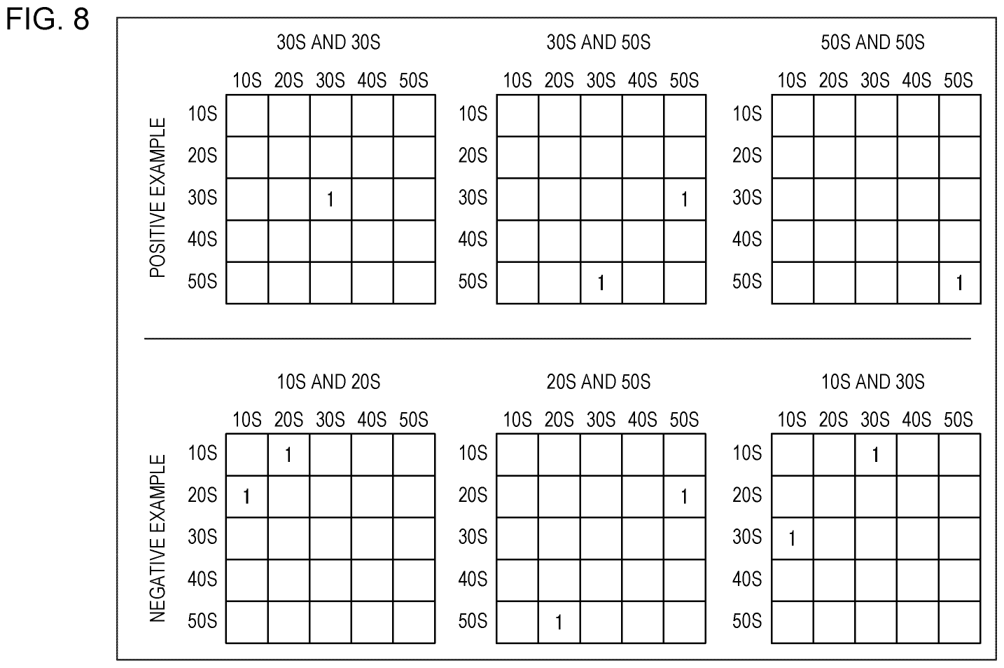

FIG. 8 is a diagram illustrating an example of information stored in the input data DB 13. As illustrated in FIG. 8, the input data DB 13 stores input data of a positive example and input data of a negative example. For example, the input data DB 13 stores, as the input data of the positive example, data in which 30s and 30s have a link, data in which 30s and 50s have a link, and data in which 50s and 50s have a link. The input data DB 13 stores, as the input data of the negative example, data in which 10s and 20s have a link, data in which 20s and 50s have a link, and data in which 10s and 30s have a link.

As an example of tensor data, an example has been described in which an adjacency matrix is stored and that is focused only on age groups of people having a link, but the present disclosure is not limited to this example. For example, data of a graph structure may be stored, and the learning apparatus 10 may generate tensor data from the data of the graph structure. Tensor data generated by an administrator or the like may also be stored.

The learning data DB 14 is a database for storing learning data to be used for learning of a deep tensor. For example, the learning data DB 14 stores learning data generated from each piece of input data stored in the input data DB 13 by the control unit 20 to be described later. Details will be described later.

The learning result DB 15 is a database that stores a learning result. For example, the learning result DB 15 stores a determination result (classification result) of learning data by the control unit 20, various parameters in a neural network that are a learning result obtained by the deep tensor, various parameters including information of an optimized target core tensor, and the like.

The prediction target DB 16 is a database for storing data of a prediction target to be predicted by using a learned learning model. For example, the prediction target DB 16 stores data of a graph structure of the prediction target, and the like.

The control unit 20 is a processing unit that controls entire processing of the learning apparatus 10 and is, for example, a processor. The control unit 20 includes a learning processing unit 30 and a prediction processing unit 40. The learning processing unit 30 and the prediction processing unit 40 are an example of electronic circuits included in a processor or the like or processes to be executed by a processor or the like.

The learning processing unit 30 includes a generation unit 31 and a learning unit 32, and performs learning using a deep tensor to construct a learning model. In the first embodiment, the learning processing unit 30 will be described by using an example in which the rule is learned in which “it is a positive example when there is a link between people in their 30s or older”, as the rule based on the ranking relationship of the labels.

The generation unit 31 is a processing unit that sets a value to an attribute in a range corresponding to the ranking relationship indicated in the rule, for each piece of input data of the positive example and the negative example stored in the input data DB 13, generates learning data, and stores the generated learning data in the learning data DB 14.

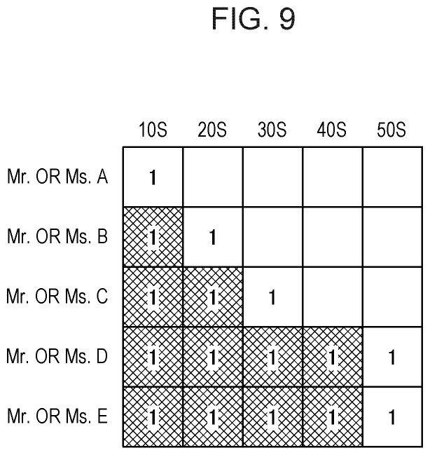

For example, when a rule such as “be equal to or larger than” is to be learned, that is, when a rule applicable to a certain ranking is also expected to be applied to an upper ranking, the generation unit 31 generates learning data in which “1” is set even to an age group equal to or younger than the corresponding age group. FIG. 9 is a diagram for explaining conversion from input data to learning data. FIG. 9 is simplified representation focusing only on relationships among people and age groups. As illustrated in FIG. 9, when the generation unit 31 learns a rule of an age group equal to or older than 30s, the generation unit 12 also sets the age groups of 10s and 20s at “1” with respect to a person corresponding to 30s.

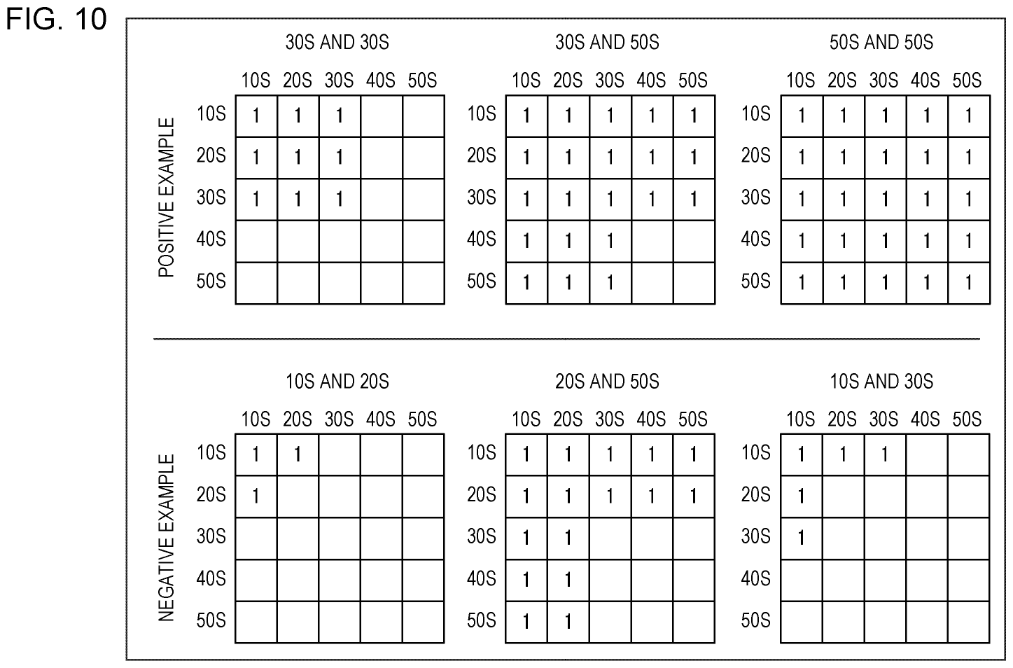

An example will be described in which learning data for learning the rule in which “it is a positive example when there is a link between people in their 30s or older” is generated from the input data illustrated in FIG. 8. FIG. 10 is a diagram for explaining a generation example of learning data. As illustrated in FIG. 10, the generation unit 31 also sets elements equal to or younger than 30s at “1” with respect to data of a positive example in which 30s and 30s have a link, illustrated in FIG. 8, and generates the learning data of the positive example. That is, for example, the generation unit 31 sets the respective elements of 10s and 10s, 10s and 20s, 10s and 30s, 20s and 10s, 20s and 20s, 20s and 30s, 30s and 10s, and 30s and 20s at “1”, in addition to the element of 30s and 30s that has already been set at “1”, with respect to the data of the positive example.

Similarly, the generation unit 31 sets the respective elements equal to or younger than 30s and equal to or younger than 50s, and the respective elements equal to or younger than 50s and equal to or younger than 30s at “1” with respect to data of a positive example in which 30s and 50s have a link illustrated in FIG. 8, and generates the learning data of the positive example. That is, for example, the generation unit 31 sets each element other than four elements of 40s and 40s, 40s and 50s, 50s and 40s, and 50s and 50s at “1” with respect to the data of the positive example.

Similarly, with respect to the data of the positive example in which 50s and 50s have a link, as illustrated in FIG. 8, the generation unit 31 sets the respective elements equal to or younger than 50s at “1”, in addition to the element of 50s and 50s that has already been set at “1”, and generates the learning data of the positive example. That is, for example, the generation unit 31 sets all elements that are the data of the positive example, at “1”.

The generation unit 31 also executes processing with respect to the data of the negative example illustrated in FIG. 8 in the same manner. For example, the generation unit 31 sets the respective elements equal to or younger than 10s and equal to or younger than 20s, and the respective elements equal to or younger than 20s and equal to or younger than 10s, at “1” with respective to the data of the negative example in which 10s and 20s have a link, and generates the learning data of the negative example. The generation unit 31 sets the respective elements equal to or younger than 20s and equal to or younger than 50s, and the respective elements equal to or younger than 50s and equal to or younger than 20s, at “1” with respect to the data of the negative example in which 20s and 50s have a link, and generates the learning data of the negative example. The generation unit 31 sets the respective elements equal to or younger than 10s and equal to or younger than 30s, and the respective elements equal to or younger than 30s and equal to or younger than 10s, at “1” with respect to the data of the negative example in which 10s and 30s have a link, and generates the learning data of the negative example.

The learning unit 32 is a processing unit that learns a learning model by using learning data. For example, the learning unit 32 reads the learning data of the positive example or the learning data of the negative example from the learning data DB 14, inputs the data to the deep tensor, and performs learning by using the method illustrated in FIG. 2. After that, when the learning is completed, the learning unit 32 stores a result of the learning in the learning result DB 15.

For example, when the learning data in FIG. 10 is used, the learning unit 32 extracts, as characteristics of the positive example, data in which “1” is set to the respective elements of 30s and 30s, 10s and 10s, 10s and 20s, 10s and 30s, 20s and 10s, 20s and 20s, 20s and 30s, 30s and 10s, and 30s and 20s, as a common point of the respective pieces of learning data of the positive example, and perform leaning of the deep tensor. The timing for terminating the learning processing may be optionally set at the time point when the learning using the prescribed number or more of the learning data is completed, at the time point when a restoration error becomes lower than a threshold value, or the like.

Referring back to FIG. 7, the prediction processing unit 40 is a processing unit that includes a generation unit 41 and a prediction unit 42, and that performs prediction by using a learned learning model.

The generation unit 41 is a processing unit that generates input data capable of prediction by setting a value to an attribute in a range corresponding to the ranking relationship indicated in the rule of the above learning target, with respect to prediction target data stored in the prediction target DB 16. The generation unit 41 generates the input data capable of prediction by the same method as that of the generation unit 31, and outputs the generated input data to the prediction unit 42.

The prediction unit 42 is a processing unit that performs prediction of a positive example or a negative example with respect to the prediction target data stored in the prediction target DB 16. The prediction unit 42 reads various parameters from the learning result DB 15, and constructs a deep tensor including a neural network or the like in which the various parameters are set. The prediction unit 42 inputs the input data capable of prediction and acquired from the generation unit 41 to the learned learning model that has been constructed, and acquires an output result (prediction result).

Thereafter, the prediction unit 42 performs prediction based on the output result. For example, the prediction unit 42 acquires a positive example probability that the prediction target data is a positive example and a negative example probability that the prediction target data is a negative example as the output result of the deep tensor, and when the positive example probability is higher, the prediction unit 42 determines that the prediction target data is a positive example. The prediction unit 42 stores the prediction result in the storage unit 12, displays the prediction result on a display unit such as a display, and transmits the prediction result to an administrator terminal.

[Description of Processing]

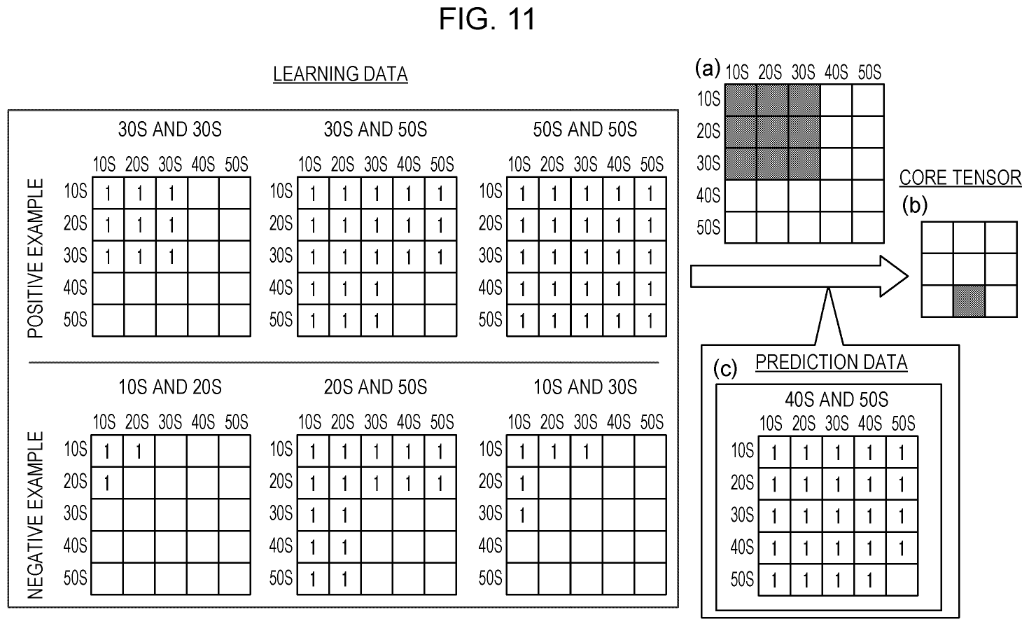

FIG. 11 is a diagram for explaining learning processing and prediction processing. As illustrated in FIG. 11, at the time of learning using a deep tensor by the learning processing unit 30, it is possible to characteristically specify that the respective elements of 30s and 30s, 10s and 10s, 10s and 20s, 10s and 30s, 20s and 10s, 20s and 20s, 20s and 30s, 30s and 10s, and 30s and 20s are “1” (see (a) in FIG. 11).

Accordingly, the deep tensor may construct a learning model by extracting a core tensor as characteristics where the above respective elements are “1” to perform learning (see (b) in FIG. 11).

Thereafter, the prediction processing unit 40 inputs the prediction target data in which 40s and 50s have a link illustrated in (c) in FIG. 11 to the learned learning model. The prediction target data is input data that is capable of prediction and in which the respective elements equal to or younger than 40s and equal to or younger than 50, and the respective elements equal to or younger than 50s and equal to or younger than 40 are set at “1”. That is, for example, it is input data that is capable of prediction and in which only the element of 50s and 50s is “0”.

Therefore, prediction target data matches the learned characteristics in which the respective elements of 30s and 30s, 10s and 10s, 10s and 20s, 10s and 30s, 20s and 10s, 20s and 20s, 20s and 30s, 30s and 10s, and 30s and 20s are “1”. As a result, the prediction target data is determined to be a positive example.

[Processing Procedure]

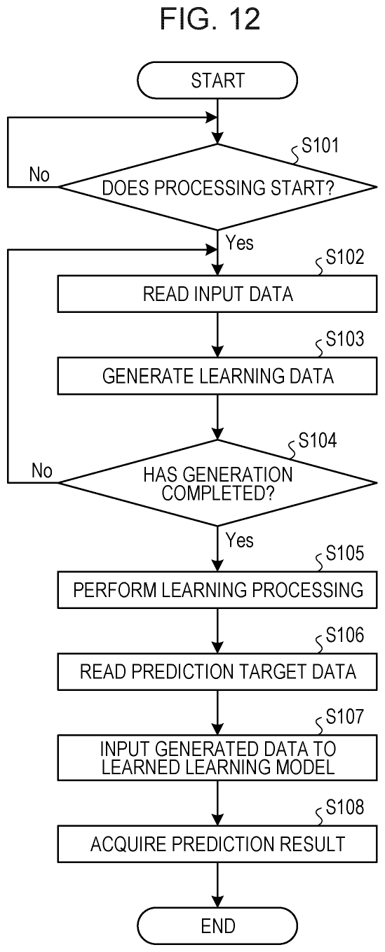

FIG. 12 is a flowchart illustrating a processing procedure according to the first embodiment. As illustrated in FIG. 12, when processing start is instructed (S101: Yes), the learning processing unit 30 reads input data from the input data DB 13 (S102), generates learning data, and stores the generated learning data in the learning data DB 14 (S103).

After that, until generation of pieces of learning data for all pieces of input data is completed (S104: No), the process of S102 and subsequent steps are repeated. On the other hand, when the generation of the learning data is completed (S104: Yes), the learning processing unit 30 performs learning processing using the learning data to construct a learning model (S105).

Thereafter, the prediction processing unit 40 reads the prediction target data from the prediction target DB 16 (S106), generates input data capable of prediction, and inputs the generated input data to the learned learning model (S107). The prediction processing unit 40 acquires a prediction result from the learned learning model (S108).

[Effects]

As described above, the learning apparatus 10 uses a fact that common characteristics according to the ranking occur between attribute values by using tensor representation having a value in a range corresponding to a ranking relationship. When learning is performed by a deep tensor by using such tensor representation as input, characteristics common to the attribute values included in the learning data are extracted into a core tensor. Since characteristics in consideration of common points of attribute values are simpler than those in which attribute values are individually taken into consideration as described in the problem of the common technique, the method according to the first embodiment easily extracts the characteristics common to the attribute values into the core tensor. At this time, the extracted characteristics are contents that the ranking relationship is considered, and the rule based on the ranking relationship may be learned. Therefore, the learning apparatus 10 may perform appropriate learning and prediction even when the learning data is not enough (the attribute values are not sufficiently present).

### Second Embodiment

In the first embodiment, the case has been described where a rule such as “be equal to or larger than” is to be learned, but the present disclosure is not limited thereto, and rules such as “be equal to or smaller than” may also be learned. Therefore, in the second embodiment, an example will be described in which a rule in which “it is a positive example when there is a link between people in their 30s or younger” is learned.

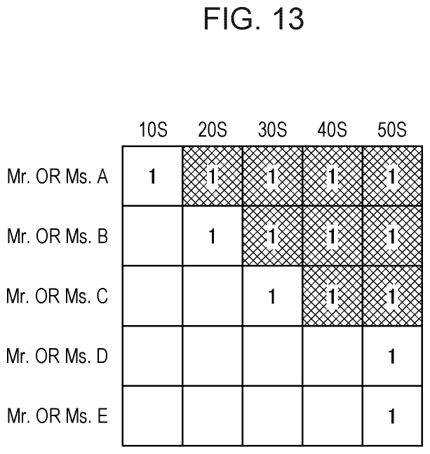

When the rule such as “be equal to or smaller than” is to be learned, that is, for example, when a rule applicable to a certain ranking is also expected to be applied to a lower ranking, learning data is generated in which “1” is set even in an age group equal to or older than the corresponding age group. FIG. 13 is a diagram for explaining conversion from input data to learning data, according to the second embodiment. FIG. 13 is simplified representation focusing only on relationships among people and age groups. As illustrated in FIG. 13, when the learning processing unit 30 learns a rule of an age group equal to or younger than 30s, the learning processing unit 30 also sets the age groups of 40s and 50s at “1” with respect to a person corresponding to 30s.

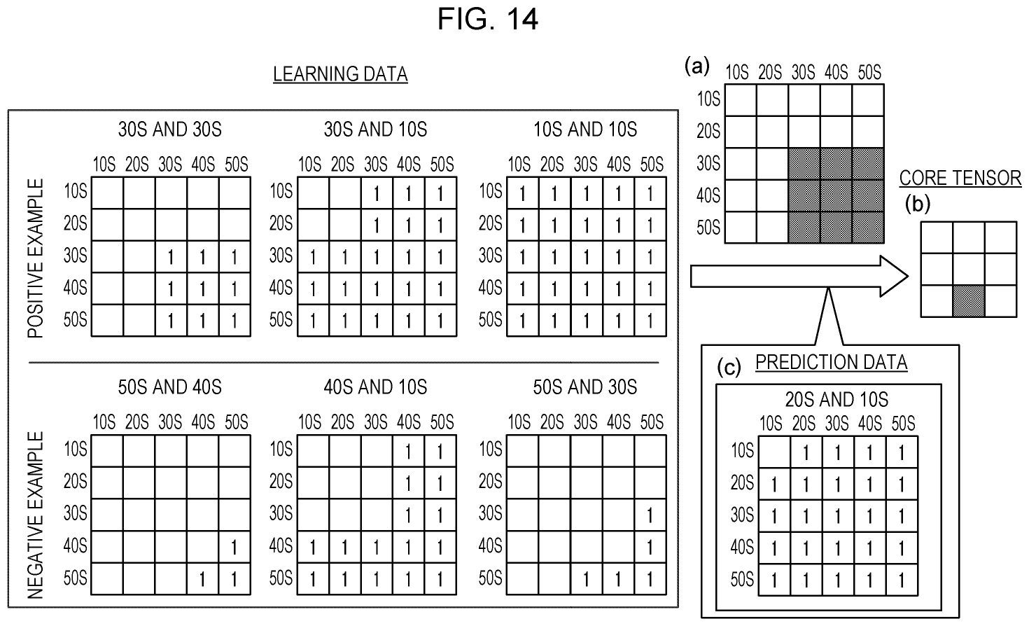

An example will be described in which the rule in which “it is a positive example when there is a link between people in their 30s or younger” is learned by using FIG. 14. FIG. 14 is a diagram for explaining learning processing and prediction processing according to the second embodiment.

As illustrated in FIG. 14, with respect to data of a positive example in which 30s and 30s have a link illustrated in FIG. 8, the learning processing unit 30 generates learning data of the positive example in which “1” is also set to elements equal to or older than 30s. That is, for example, with respect to the data of the positive example, the learning processing unit 30 sets the respective elements of 30s and 40s, 30s and 50s, 40s and 30s, 40s and 40s, 40s and 50s, 50s and 30s, 50s and 40s, and 50s and 50s at “1”, in addition to the element of 30s and 30s that has originally been set at “1”.

Similarly, with respect to data of a positive example in which 30s and 10s have a link, the learning processing unit 30 generates learning data of the positive example in which the respective elements of the respective age groups equal to or older than 30s and the respective age groups equal to or older than 10s, and the respective elements of the respective age groups equal to or older than 10s and the respective age groups equal to or older than 30s are set at “1”. That is, for example, the learning processing unit 30 sets each element other than four elements of 10s and 10s, 10s and 20s, 20s and 10s, and 20s and 20s at “1” with respect to the data of the positive example.

Similarly, the learning processing unit 30 generates the learning data of the positive example in which “1” is set in each element of age groups equal to or older than 10s with respect to the data of the positive example in which 10s and 10s have a link. That is, for example, the learning processing unit 30 sets all the elements at “1” with respect to the data of the positive example.

With respect to data of a negative example in which 50s and 40s have a link, the learning processing unit 30 generates learning data of the negative example in which the respective elements of the respective age groups equal to 50s and equal to or older than 40s, and the respective elements of the respective age groups equal to or older than 40s and equal to 50s are set at “1”.

Similarly, with respect to data of a negative example in which 40s and 10s have a link, the learning processing unit 30 generates learning data of the negative example in which the respective elements of the respective age groups equal to or older than 40s and equal to or older than 10s, and the respective elements of the respective age groups equal to or older than 10s and equal to or older than 40s are set at “1”.

Similarly, with respect to data of a negative example in which 50s and 30s have a link, the learning processing unit 30 generates learning data of the negative example in which the respective elements of the respective age groups equal to 50s and equal to or older than 30s, and the respective elements of the respective age groups equal to or older than 30s and equal to 50s are set at “1”.

The learning processing unit 30 learns, as characteristics of the positive example, that the respective elements of age groups equal to or older than 30s and equal to or older than 30s, which are a common point of the pieces of learning data of the respective positive examples, are set at “1”, by learning these pieces of learning data by a deep tensor (see (a) in FIG. 14). That is, for example, the deep tensor may construct a learning model by extracting the core tensor as characteristics where the respective elements of age groups equal to or older than 30s and equal to or older than 30s are “1” to perform learning (see (b) in FIG. 14).

Thereafter, the prediction processing unit 40 inputs prediction target data in which 20s and 10s have a link illustrated in (c) in FIG. 14 to the learned learning model. The prediction target data is input data that is capable of prediction and in which the respective elements of age groups equal to or older than 20s and equal to or older than 10s, and the respective elements of age groups equal to or older than 10s and equal to or older than 20s are set at “1”. That is, the prediction target data is input data that is capable of prediction and in which only the element of 10s and 10s is “0”.

Therefore, the prediction target data matches the learned characteristics in which the respective elements of age groups equal to or older than 30s and equal to or older than 30s are “1”. That is, the prediction target data is determined to be a positive example because the prediction target data includes the learned characteristics.

### Third Embodiment

Although the embodiments of the present disclosure have been described, the present disclosure may be implemented by various different embodiments other than the above-described embodiments.

[Numerical Values or the Like]

The data examples, the numerical values, the setting contents of the positive examples and the negative examples, the number of dimensions of the tensor, and the like used in the above-described embodiments are mere examples and may be changed in any manner. Input data using the age groups, people and the like is also an example, and various relationship data may be used. Setting at “1” in the above embodiments is an example of setting a value, similarly to processing for setting a flag, and indicates that an element to which the value is set is a corresponding element to be processed.

[Rule Example]

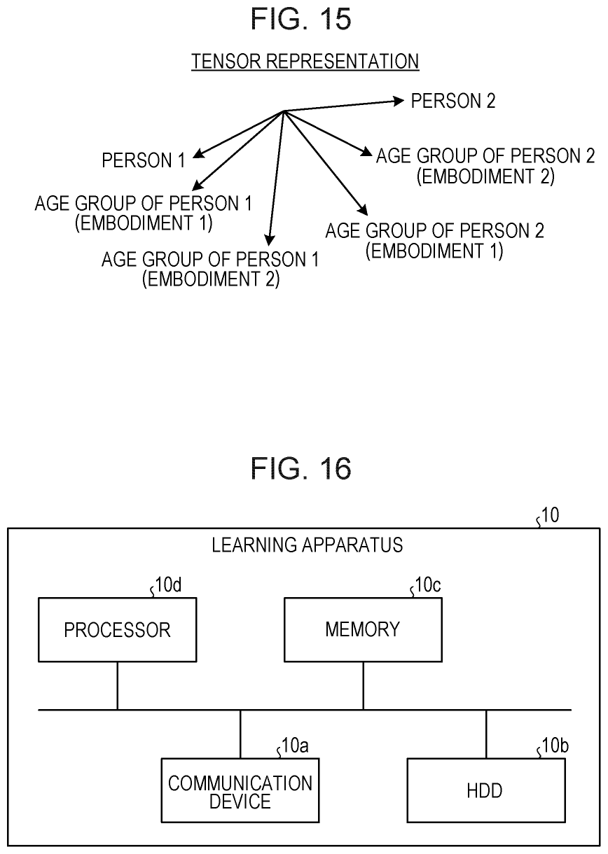

Besides the rules described in the above embodiments, it is possible to learn a rule such as “be equal to or larger than, and equal to or smaller than”. FIG. 15 is a diagram for explaining tensor representation of learning data according to the third embodiment. As illustrated in FIG. 15, when the rule such as “be equal to or larger than, and equal to or smaller than” is learned, tensor representation of learning data is applied with each attribute as a dimension, so that a space represented by each axis of the person 1 and the age group of the person 1 (first embodiment), the age group of the person 1 (second embodiment), the person 2 and the age group of the person 2 (first embodiment), and the age group of the person 2 (second embodiment) is set at 1. That is, for example, when it may be expected that a rule applicable for two rankings is applied to a ranking between the rankings, the age group in the tensor representation is defined as representation divided into the age group based on the method according to the first embodiment and the age group based on the method according to the second embodiment. That is, for example, a portion of “be equal to or larger than” is learned in the age group of the first embodiment, and a portion of “be equal to or smaller than” is learned in the age group of the second embodiment, so that it is possible to learn the rule such as “be equal to or larger than and equal to or smaller than”.

[System]

Processing procedures, control procedures, specific names, information including various kinds of data and parameters represented in the documents or drawings may be optionally changed unless otherwise specified.

Each configuration element of each device illustrated in the drawings is functionally conceptual, and is not necessarily physically configured as similar as the drawing. In other words, the specific form of distribution or integration of each device is not limited to those illustrated in the drawings. That is, for example, all or a part of them may be configured to be functionally or physically distributed or integrated into optional units according to various loads, usage conditions, or the like. For example, the learning processing unit 30 and the prediction processing unit 40 may be installed in different devices.

All or a part of each processing function performed in each device may be enabled by a CPU and a program that is analyzed and executed by the CPU, or may be enabled as hardware by wired logic.

[Hardware]

FIG. 16 is a diagram for explaining an example of a hardware configuration. As illustrated in FIG. 16, the learning apparatus 10 includes a communication device 10a, a hard disk drive (HDD) 10b, a memory 10c, and a processor 10d. The respective units illustrated in FIG. 16 are coupled to one another by a bus or the like.

The communication device 10a is a network interface card or the like, and performs communication with other servers. The HDD 10b stores a program or a DB for operating a function illustrated in FIG. 8.

The processor 10d reads, from the HDD 10b or the like, a program for executing substantially the same processes as those of the processing units illustrated in FIG. 8 and loads the program into the memory 10c, thereby executing a process of performing the functions described with reference to FIG. 8 and the like. The processes implement the same functions as those of the processing units included in the learning apparatus 10. Specifically, for example, the processor 10d reads the program that includes the same functions as those of the learning processing unit 30, the prediction processing unit 40, and the like from, for example, the HDD 10b. The processor 10d executes the processes that perform the same processes as those of the learning processing unit 30, the prediction processing unit 40, and the like.

As described above, the learning apparatus 10 functions as an information processing apparatus that implements a learning method by reading and running the program. The learning apparatus 10 may also implement the same functions as those of the embodiments described above by reading the program from a recording medium with the use of a medium reading device and running the read program. The program described in other embodiments is not limited to a program that is run by the learning apparatus 10. For example, the present embodiment may be similarly applied to a case where another computer or server executes the program, or a case where these cooperate to execute the program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a process comprising:
accepting graph data having a graph structure that includes a plurality of nodes and attributes respectively set to the plurality of nodes;
generating tensor data which has a dimension corresponding to each of the plurality of nodes and each of the attributes, and in which a relationship value indicating existence of a corresponding relationship is set for first relationships between the plurality of nodes and the attributes and second relation ships between the plurality of nodes; and
upon learning ranking relationships between the attributes by using each of the attributes as a label, setting the relationship value to an attribute value range of each of the attributes in the tensor data, the attribute value range corresponding to the ranking relationships.

2. The non-transitory, computer-readable recording medium of claim 1, wherein
the setting includes, upon learning first ranking relationships between first attributes each expected to have an attribute value equal to or greater than a predetermined value, setting the relationship value to first elements among elements of first tensor data generated from the graph data corresponding to relationships between predetermined attributes, the first elements corresponding to attribute values equal to or lower than an attribute value set to each of the predetermined attributes.

3. The non-transitory, computer-readable recording medium of claim 1, wherein
the setting includes, upon learning first ranking relationships between first attributes each expected to have an attribute value equal to or lower than a predetermined value, setting the relationship value to first elements among elements of first tensor data generated from the graph data corresponding to relationships between predetermined attributes, the first elements corresponding to attribute values equal to or greater than an attribute value set to each of the predetermined attributes.

4. The non-transitory, computer-readable recording medium of claim 1, the process further comprising:
performing learning of a neural network by using the tensor data in which the relationship value has been set to elements of the attribute value range of the tensor data corresponding to the ranking relationships.

5. The non-transitory, computer-readable recording medium of claim 1, wherein:
in the graph data, a person information item indicating a person is set as each of the plurality of nodes, an age group of a person is set as an attribute of each of the plurality of nodes, and nodes whose person information items are related to each other are connected;
in the tensor data, each person information item is defined as a dimension, each age group is defined as a dimension, and the relationship value is set to elements of the tensor data corresponding to first age groups that are set to first person information items and second person information items related to the first person information items; and
upon learning first ranking relationships between the first age groups, the relationship value is set to elements of a first attribute value range of the tensor data corresponding to the first ranking relationships.

6. A method performed by a computer, the method comprising:
accepting graph data having a graph structure that includes a plurality of nodes and attributes respectively set to the plurality of nodes;
generating tensor data which has a dimension corresponding to each of the plurality of nodes and each of the attributes, and in which a relationship value indicating existence of a corresponding relationship is set for first relationships between the plurality of nodes and the attributes and second relation ships between the plurality of nodes; and
upon learning ranking relationships between the attributes by using each of the attributes as a label, setting the relationship value to an attribute value range of each of the attributes in the tensor data, the attribute value range corresponding to the ranking relationships.

7. An apparatus comprising:
a memory; and
a processor coupled to the memory and configured to:
accepting graph data having a graph structure that includes a plurality of nodes and attributes respectively set to the plurality of nodes,
generate tensor data which has a dimension corresponding to each of the plurality of nodes and each of the attributes, and in which a relationship value indicating existence of a corresponding relationship is set for first relationships between the plurality of nodes and the attributes and second relation ships between the plurality of nodes, and
upon learning ranking relationships between the attributes by using each of the attributes as a label, set the relationship value to an attribute value range of each of the attributes in the tensor data, the attribute value range corresponding to the ranking relationships.
